(19) United States
(12) Patent Application Publication
(10) Pub. No.: US 2004/0173028 A1
(43) Pub. Date: Sep. 9, 2004

(54) Electroconductive textile sensor

(76) Inventor: Robert Rix, Southport (GB)

Correspondence Address: Benita J Rohm, Rohm & Monsanto, Suite 1525, 660 Woodward Avenue, Detroit, MI, 48226, US

(21) Appl. No.: 10/475,579

(22) PCT Filed: Apr. 15, 2002
(86) PCT No.: PCT/GB02/01732

(30) Foreign Application Priority Data
Apr. 27, 2001 (GB) 0110330.8
Jul. 5, 2001 (GB) 0116348.4

(51) Int. Cl. G01L 1/00

(52) U.S. Cl. 73/780

(57) ABSTRACT

A sensor, ideally for a car seat, is disclosed in which an electro-conductive textile (ECT) is used to simultaneously deliver energy to the occupant to the seat in the form of heat, and to sense the nature or characteristics of the occupant of that seat. To achieve these functions, the ECT is connected to both a control circuit and a charge transfer/capacitance measuring circuit. The control circuit ensures that the ECT does not become too hot during use, and the charge transfer/capacitance measuring circuit is capable of determining not only if the seat is occupied but also the nature of the occupant, in particular the size and/or weight.

This invention relates to an improved sensor, and mote particularly to a sensor which has a dual function of sensing the presence or absence of a secondary object proximate or adjacent said sensor and delivering energy to that secondary object. The sensor is ideally used to provide a control signal to a related system or apparatus, said control signal being capable of not only indicating the presence or absence of said secondary object but also the nature of said secondary object.

Although the following description is provided with almost exclusive reference to the use of electro-conductive textiles (ECTs) through which an optionally variable electric current can be passed to cause the temperature of the ECT to increase and thus act as a means for delivering heat to an adjacently disposed secondary object, it is to be appreciated that the following invention is not to be considered as exclusively limited to this particular application, and indeed the invention may be applicable to number of different applications in which the sensor is capable of conducting electricity therethrough to perform some function other than the sensing operation simultaneously.

U.S. Pat. No. 6,172,344 to Gordon and others describes an ECT in combination with an electronic control circuit which allows for the temperature of the ECT to be maintained at a predetermined and desired temperature with only negligible variation therefrom. In this document there is also described the use of such an ECT to provide a heating function for the occupant of a vehicle seat by embedding the ECT within the seat beneath the standard cloth used in the manufacture of such seats. It will be clear to those skilled in the art that the use of an ECT within vehicle and other seats is advantageous when compared to the alternative of embedding an electrical resistance element in those parts of the seat which are desired to be heat, as the ECT can be cut, shaped, and made to flexibly adopt the contour of the seat very easily.

The control circuit for the ECT may ideally be located remote from the seat, but this is not essential as the ECT is additionally an inherently safe means of providing a heating function for a seat. Furthermore the uniformity of heating over the entire surface of the ECT is manifested in a comfortable rise in the temperature of particular seat surfaces as a whole as opposed to the localised heating which often occurs as current is passed through an electrical resistance element.

In addition to the possibility of providing a heating function for the seats of vehicles, the reader will be aware that the majority of vehicles currently manufactured are now fitted with one or more air bags in front of at least the front driver seat and in some cases the front passenger seat to prevent injury through impact of the occupant of those seats with the fascia or other solid component, such as the steering wheel, immediately in front of the seats in the event of a vehicle collision. The reader will also be aware that in more expensive vehicles, side air bags are sometimes provided within the internal door skins to protect the occupant from any object impacting the vehicle from one or other side.

The applicants for the present invention have been investigating possible enhancements to the idea of embedding ECTs in vehicle seats to provide heating therefor (a concept which is disclosed in the previously mentioned US patent), and during their investigation they have discovered firstly that a few vehicle manufacturers include sensors within the seat which communicate with an air bag deployment system to provide a so-called intelligent air bag system wherein the air bag is only deployed when the seat is occupied. It seems that only relatively few vehicle manufacturers currently provide such intelligent air bag systems although their number is increasing, and in general manufacturers simply install air bags which are deployed when a sufficiently violent vehicle impact is detected regardless of whether a particular seat is occupied or not.

Secondly, the applicants have ascertained that where sensors are provided within the seat structure, they can take a number of different forms. A common sensor comprises a matrix of metal strips which are either disposed beneath or embedded within the seat and thus compromise the comfort of the seat to the occupant. The sensor achieves its function by virtue of the tension to which such metal strip matrices are subjected when a person disposes himself in the seat. As a necessary result of the mode of operation of such matrices, the metallic strips are prone to breakage, particularly when it is considered that in sitting in a car seat, the entire weight of a particular person will effectively drop into the seat from above and to one side of the seat, and therefore although the matrices may function adequately to provide a sensing signal when a person is seated in the seat, occasionally the matrices are subjected to momentary and significantly greater forces than simply the weight of the person. Additionally, persons frequently move even when seated within the seat, and thus the matrices are being continually subjected to varying forces depending on how the person moves within the seat.

In other intelligent air bag systems, the sensor may be embodied in some form of distensible bladder having a compressible medium therein such as air, liquid, or gel which is displaced under load. These type of sensors are additionally disadvantaged in that the bladders can be punctured or torn by sharp objects worn or carried by a person which may be accidentally or unknowingly forced into the seat.

In very basic systems, the arming of the air bag deployment mechanism can be achieved by virtue of simple occupancy sensors, such as those commonly used in modern car alarms which detect only the presence of a human in the cabin of a vehicle as opposed to whether a seat is occupied or not.

The primary disadvantage of all these systems is that they lack versatility and provide insufficient feedback to the air bag deployment system, and accordingly current systems are known as passive systems. In the main, current air-bag deployment systems operate in a binary manner and take no account of the nature of the person occupying the seat at the time of violent impact. In short, air bags ate generally only deployed when a positive indication is received from the sensor, and not deployed in any other circumstances.

In the case where air bags are installed but no air-bag deployment system is provided, the air bags are configured to deploy regardless of whether a seat is occupied or not, and therefore in the event of an accident, there will usually be some requirement to replace the deployed air bags, provided that the vehicle is not irretrievably damaged by the violent impact. Alternatively, where an air-bag deployment system is provided and an item of luggage or the like is placed on a seat having a sensor therein, the system may mistakenly believe that the seat is occupied by a person and deploy the air bag again unnecessarily.

The replacement and installation of air bags in vehicles is an expensive exercise and requires fully trained and qualified personnel as air bags include a highly sensitive explosive or other pyrotechnic device. It is therefore preferable for manufacturers to fit some type of sensor and an air bag deployment system to prevent needless deployment of air bags.

A yet further disadvantage of intra-seat sensors is that they are generally very cumbersome and difficult to install.

In the field of sensing technology, Quantum Research Group Limited (www.qprox.com) have been awarded U.S. Pat. No. 5,730,165, currently in the name of Philipp which relates to a capacitive field sensor, which may ideally be used for the control of a water supply in a basin or fountain, employing a single coupling “plate” whose capacitance to ground changes depending on the proximity or remoteness of a foreign body, for example the hand of a user. The invention involves the use of a circuit for charging a sensing plate and a switching element active to remove charge from the sensing plate and to transfer it to a charge detection circuit including a capacitance of a known value and by which the unknown capacitance of the sensing plate can be determined. The time interval employed for the charging and discharging steps can vary widely. Usually at least one of the charge or discharge pulses is of the order of a hundred nanoseconds, and is shorter in duration than a characteristic conduction time for a body of water disposed about the sensing plate. In this manner the sensor can detect the presence of a user near a controlled faucet without being subject to measurement artefacts arising from standing water. In a controller for a water basin, a short charge or discharge pulse duration may be used when the controlled valve is closed, and a longer duration, which allows conduction through the water, may be used when the valve is open. The long duration measurement can detect the continued presence of the user as long as the user's hand remains in the stream of water.

Although the patent is predominantly concerned with the detection of the hand of a user proximate the sensor when connected to a water faucet, the patent is not limited throughout to this feature, at least in one aspect. Specifically, the scope of protection afforded by this patent is limited by the requirement for connecting the plate to ground with a “shunting conductor that is not part of the sensor”. In the case where the sensor is employed within a faucet, the body of water spilled around the sensing plate acts as the shunting conductor, which can be theoretically represented as a two dimensional array of infinite series of resistors and capacitors connected between the plate and earth. Such a circuit can act as a low pass filter with an upper cut-off or threshold frequency above which the circuit will not respond. Inversely, a current waveform having a pulse width less than a threshold value will not cause the circuit to respond or conduct to any great extent. It is this phenomenon which permits the device to work with great effectiveness.

The invention further requires a discharging switch is operated with a voltage pulse having a duration less than the abovementioned threshold pulse duration so that the shunting conductor does not adversely affect the capacitance measurement.

Additionally, U.S. Pat. No. 4,879,461 to Philipp, which allegedly is the property of Quantum Research Group, describes an energy field disturbance sensor comprising an energy field emission means such as a light emitting diode; the emitted field possibly containing a time-varying component. An energy sensing device such as a photodiode receives the field energy to produce a sensing signal related to the intensity of the emitted field and any disturbance therein. A second signal complementary to the sensed signal is added in a summing junction to the sensing signal to create a summation signal. If the emitted energy field contains a time-varying component, a detection circuit is used to sample the summation signal to convert the summation signal to a proportional detection signal. An analog to digital converter converts the detection signal to a digital form. Digital processing circuitry modulates the amplitude of the complementary signal or the intensity of the energy field according to the desired mode of operation, and in accordance with the behaviour of the digital detection signal and external control signals. The circuitry is capable of creating a null condition in the detection signal when the received amplitude of the energy field is such that when added to the complementary signal a cancellation effect occurs; the null condition may be transient or continuous in nature depending on the mode of operation and the nature of the field disturbance.

Although these two disclosures appear initially unrelated to the field of sensing passenger or driver seat occupancy, they both make use of the physical phenomenon that all articles possess some degree of capacitance, and furthermore that an amount of mutual capacitance will exist between two objects regardless of how proximally or remotely disposed of one another they are. Qprox™ sensors (which are manufactured by Quantum Research Group) work by placing a fixed voltage on an object thus charging same then re-capturing the charge and transferring this charge to a measurement circuit. QProx™ first measures the background amount of capacitance on an object, and treats that like a ‘tare’. It then looks at very small changes in the measured signal from that point on, caused by nearby objects. While early capacitance sensing technology could monitor changes in capacitance, QProx™ is superior at ignoring huge amounts of background capacitance automatically and this allows for a practically vast number of objects to be turned into sensors.

It is an object of this invention to provide a novel use for this sensing technology in a previously undisclosed field of application.

It is a further object of the invention to provide a means of simultaneously passing an electric current through an object by virtue of which that object can deliver energy or perform its function and using the instantaneous charge extant on that object as a means of determining whether and to what degree a secondary object is proximate to the object.

According to a first aspect of the invention there is provided a seat in which the presence or absence of a human is desired to be detected, characterised in that the seat is provided internally with a layer of an ECT, said ECT being provided with electrical connection means by which charge transfer/capacitance sensing apparatus are connected, said charge transfer/capacitance sensing apparatus having an output connected to tertiary apparatus which becomes operable or inoperable depending on said output.

Preferably the seat is provided with a seat portion which support the buttocks of a human, said ECT being provided internally of said seat and beneath said seat portion such that the ECT is caused to deform in a similar manner to the seat portion when a human is seated thereon.

Most preferably, said seat is provided internally with a second and further layers of ECT optionally electrically interconnected, at least one of said second and further layers being disposed internally but immediately behind the seat portion and any back test portion of the seat, said second and further ECT layers having electrical connection means by which a current can be supplied thereto, power being dissipated therein as heat to warm the occupant.

Preferably the charge transfer/capacitance sensing apparatus which is connected to the first ECT layer is separate from a control circuit which is connected to the second and further ECT layers to control the heating effect they provide.

Most preferably, the seat is manufactured with the one and second and further ECT layers therein and provided with external electrical connection means through which connection of remotely and externally disposed charge transfer/capacitance sensing apparatus can be achieved.

Most preferably a separate set of external electrical connection means is provided whereby the control circuit for controlling the heating function of the second and further ECT layers is connected.

According to a second aspect of the invention there is provided an ECT and an associated control circuit which delivers an electric current to the ECT through which said current can pass to raise the temperature thereof to a predetermined level and provide a heating effect, characterised in that measuring apparatus is coupled to said ECT which provides an indication of a secondary characteristic of said ECT which is dependent on the nature of a secondary object and/or its proximity to said ECT, the sensitivity of said measuring apparatus being of a sufficient degree so that the measured secondary characteristic provides an indication not only of the existence of a secondary object proximate the ECT but also of one or more characteristics of the nature of said secondary object, said measuring apparatus being coupled to tertiary apparatus which operates on said secondary object in a variable manner depending on said received indication.

Preferably, the measuring apparatus is a capacitance measuring apparatus which is capable of providing an indication of the size, shape, position and/or weight of said secondary object, which is preferably a human individual, and the secondary characteristic measured is preferably mutual capacitance between the ECT and the human.

Preferably, said tertiary apparatus is an airbag deployment system which variably deploys an airbag, such as for example in different directions or with differing deployment forces depending on the indication of the size, shape, position and/or weight of the individual.

Most preferably the control circuit comprises two functional elements, the first of which operates to provide a sensing capability, and the second of which operates to deliver a current to the ECT for the purposes of providing a heating function, switching means additionally being provided which cause said first and second functional elements to operate alternately for variable periods of time and exclusively of the other element.

In this manner, the ECT can be used as a general sensor for all sensing applications, and furthermore it is possible in the context of vehicle seats and in the light of the qualities of the ECT, to laminate a single piece of ECT either to the seat trim fabric or to embed the ECT into the foam cushion of the seat. In this manner, a sensor can be integrated within the seat having practically wear-proof flexibility without any diminution in the comfort of the resulting seat to the user.

In an alternative embodiment, the ECT sensor may be located upon or within the part of a car seat commonly referred to as a “plus pad”. This is a sheet or sheets of foam sometimes laminated to a scrim that is positioned between the foam cushion of the seat and the seat outer trim fabric as an aid to comfort.

In the majority of cases where any sensor system is currently employed, a plus pad is used to disguise the feel of the sensor within the seat. Henceforth, the location of plus pads is ideal for the sensor of the present invention, particularly when it is considered that a trim shop may remove the existing outer seat covers, fit a simple but combined sensing plus pad and re-fit the seat cover with minimal disturbance to the rest of the vehicle seat.

A further advantage of the present invention arising from the nature of ECTs is that the sensor can be shaped, cut, torn or otherwise formed into any desired shape without any or with only minimal reduction in performance. Additionally, the puncturing or tearing of ECT materials does not compromise their operation as opposed to bladder type sensors mentioned earlier which fail totally in such instances.

In a different embodiment of the invention, the ECT in combination with the capacitance measuring apparatus may be scaled up for use in hospital and other beds where a heating blanket may be required. For example, the heating blanket of ECT may be caused only to pass current when the presence of a patient in the said bed is detected or indicated by the capacitance measuring apparatus. Indeed, the invention has application to any human support whereat there may also be requirement to provide a heating function for the human supported. Beds and chairs form two examples of such, but it should be mentioned that the more important aspect of the invention is as a means of assessing the nature and characteristics of an object situated on or disposed adjacent the ECT with a view to controlling the degree to which a tertiary system acts, such as in controlling the force with which an airbag deploys.

The sensitivity of the capacitance measuring apparatus may be such that the device as a whole may be used to detect certain categories of occupant (for example children or adults) and provide different heating or airbag deployment functions dependent on the particular category of human detected.

In a yet further alternative embodiment, the invention could be applied in the field of animal heating blankets and the like.

The applicants have thus far determined that three different configurations for connecting the various components, that is the capacitance sensing device, the ECT and any control system therefor, of the invention together, described as follows:

1. A single piece of ECT with a one conductor single core shielded wire connection to the capacitance measuring PCB, the shielding of which is peeled back and insulated from the ECT but connected to the PCB;

2. A single piece of ECT on the outer edge of which a one conductor un-shielded wire or single core shielded wire connection is made to the PCB and two separate conductors affixed to the ECT to form buz-bars for the application of an electrical potential thereacross to render resistance heating within the ECT immediately adjacent the sensor connection, and

3. The configuration described above in (1) but placed over or under an electrically separate and insulated section of ECT forming a heater pad arranged with parallel buz-bars by which an electrical potential is applied across that second piece of ECT. The advantage of this approach is that a relatively small sensor section can have the capacitance sensing field increased in size due to the encroachment of the field over the second larger passive heater piece.

1. A sensor for detecting the proximity of body disposed thereabove, said sensor including at least one layer of an electro-conductive textile (ECT), characterised in that said ECT is provided with electrical connection means by which charge transfer/capacitance sensing apparatus are connected, said charge transfer/capacitance sensing apparatus having an output connected to tertiary apparatus which is capable of operating in a manner which influences said body, the operation of said tertiary apparatus being dependent on the output of said charge transfer/capacitance sensing apparatus.

2. A sensor according to claim 1 charactetised in that the ECT is provided internally within a seat adapted to support a human individual.

3. A sensor according to claim 2 characterised in that the seat is provided with a seat portion which support the buttocks of a human, said ECT being provided internally of said seat and beneath said seat portion such that the ECT is caused to deform in a similar manner to the seat portion when a human is seated thereon.

4. A sensor according to any preceding claim characterised in that the ECT is provided with electrical connection means by which a current can be supplied thereto, power being dissipated therein as heat to warm the body.

5. A sensor according to any of claims 2-4 characterised in that said seat is provided internally with a second and further layers of ECT electrically interconnected, at least one of said second and further layers being disposed internally but immediately behind the seat portion and/or a back rest portion of the seat.

6. A sensor according to claims 5 characterised in that the charge transfer/capacitance sensing apparatus which is connected to the first ECT layer is separate from a control circuit which is connected to the second and further ECT layers to control the heating effect they provide.

7. A seat incorporating the sensor disclosed in any of claims 1-6.

8. A seat according to claim 7 characterised in that the seat is manufactured with the one and second and further ECT layers therein and provided with external electrical connection means through which connection of remotely and externally disposed charge transfer/capacitance sensing apparatus can be achieved.

9. A seat according to claim 8 characterised in that a separate set of external electrical connection means is provided whereby the control circuit for controlling the heating function of the second and further ECT layers is connected.

10. A sensor for detecting the proximity of a body including an ECT and an associated control circuit which delivers an electric current to the ECT through which said current can pass to raise the temperature thereof to a predetermined level and provide a heating effect, characterised in that measuring apparatus is coupled to said ECT which provides an indication of a secondary characteristic of said ECT which is dependent on the nature of a secondary object and/or its proximity to said ECT, the sensitivity of said measuring apparatus being of a sufficient degree so that the measured secondary characteristic provides an indication not only of the existence of a secondary object proximate the ECT but also of one or more characteristics of the nature of said secondary object, said measuring apparatus being coupled to tertiary apparatus which operates on said secondary object in a variable manner depending on said received indication.

11. A sensor according to claim 10 characterised in that the measuring apparatus is a capacitance measuring apparatus which is capable of providing an indication of the size, shape, position and/or weight of said secondary object, which is preferably a human individual, and the secondary characteristic measured is preferably mutual capacitance between the ECT and the human.

12. A sensor according to claims 10 or 11 characterised in that said tertiary apparatus is an airbag deployment system which variably deploys an airbag, such as for example in different directions or with differing deployment forces depending on the indication of the size, shape, position and/or weight of the individual.

13. A sensor according to any of claims 10-12 characterised in that the control circuit comprises two functional elements, the first of which operates to provide a sensing capability, and the second of which operates to deliver a current to the ECT for the purposes of providing a heating function, switching means additionally being provided which cause said first and second functional elements to operate alternately for variable periods of time and exclusively of the other element.

14. A seat for a human individual incorporating the sensor of claims 10-13.

15. A seat according to claim 14 characterised in that the sensor is incorporated into or provided on a plus pad within said seat.

16. A bed incorporating the sensor of either of claims 1 or 10.

17. An animal heating blanket incorporating the sensor of either of claims 1 or 10.
